(19) United States
(12) Patent Application Publication
(10) Pub. No.: US 2023/0068843 A1
(43) Pub. Date: Mar. 2, 2023

(54) Candle with lighting embodiments

(71) Applicant: John Francis Senrau, Medaryville, IN (US)

(72) Inventor: John Francis Senrau, Medaryville, IN (US)

(21) Appl. No.: 17/411,214

(22) Filed: Aug. 25, 2021

(51) Int. Cl. F21S 6/00; F21S 4/28; F21V 29/10

(52) U.S. Cl. CPC F21S 6/001; F21S 4/28; F21V 29/10; F21Y 2115/10

(57) ABSTRACT

LEDs have been around since the 1960's, and candles have been use for many thousands of years. Until now there hasn't been an effective, safe and creative way of bringing the two together. This project utilizes both factors; it can be just a burning candle, an LED show or it can be a great smelling candle with a dazzling light show that customers are invited to help choreograph, and whose input is critical!

### BACKGROUND

The use of Light Emitting Diodes (LED's) has been in commercial use since 1968 by Monsanto. Their initial color of red has expanded as did most of their parameters. Their most commonly recognized variable, their color, is available in at least a dozen possibilities. The high level of illumination (lumens) has made it possible for them to be used as high intensity flash lights. The inventor's previous experience in the field of candle making in conjunction with current understanding of electronics has led to an epiphany of combing both worlds, resulting in a usable candle in the traditional sense, and embedded in it are lights (LED's) that can be turned on/off. The LED's are controlled by a microcontroller, which choreographs the sequencing of the LED's into any imaginable pattern, while giving consideration to the fact that this system is battery driven. There are three options, one is to burn the candle and run the LED's. Secondly, just the candles can be used, or thirdly, just the LED's can be turned on.

### DESCRIPTION OF DRAWINGS

FIG. 1 An embodiment with the vertical columns attached to the base. The view of the image is skewed/stretched to provide a better view. The text message is included in this drawing, customers will be able to choose from a list of different messages. The on/off switch is located towards the area of the text message. The LEDs have been placed into the vertical columns and their connecting wire leads are drawn through a hole at the base, to be connected further circuitry inside the base.

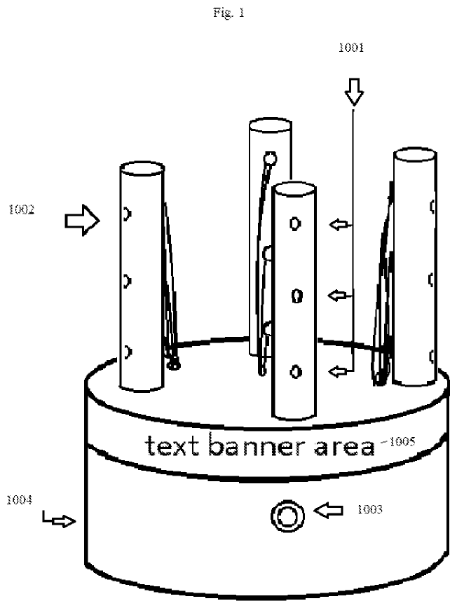

FIG. 2 An embodiment with the vertical columns attached to the base. The wax insert is above the base to illustrate the principle placement of LEDs in respect to the wax insert when they are joined together. The view of the image is skewed/stretched to provide a better view. The text message is included in this drawing, customers will be able to choose from a list of different messages. The on/off switch is located towards the area of the text message. The LEDs have been placed into the vertical columns and their connecting wire leads are drawn through a hole at the base, to be connected further circuitry inside the base.

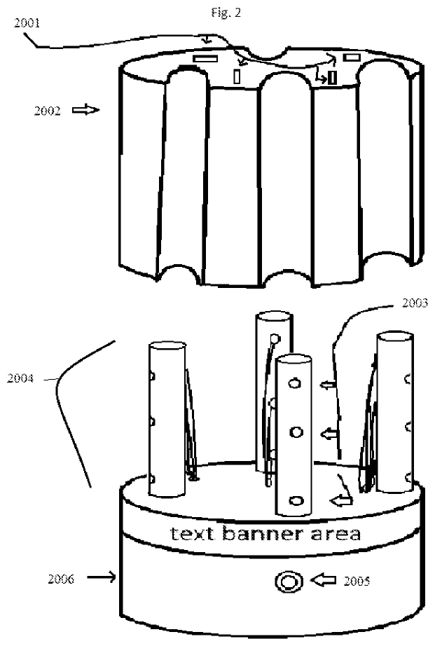

FIG. 3 The extended horizontal platform is shown with its support arms connected to itself and the support platform. The “wire path” in the central area encloses the necessary wiring for the LEDs of the platform. The view/perspective is stretched/skewed to provide a better understanding of the principles involve with this project. Under normal circumstances the placement of the 4 vertical columns would be 90 degrees apart. The first at 0 degrees, the second at 90 degrees, the third at 180 degrees, and the forth at 270 degrees.

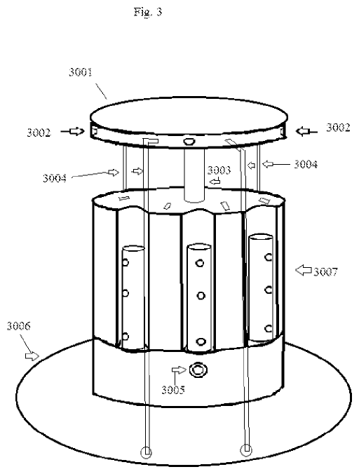

FIG. 4 Shows the assembled wax insert positioned into the base. At this point, the clear sleeve of FIG. 12 may be fitted over the edge of the base to allowing the inclusion of a clear wax to fill areas that are not yet wax filled. The clear sleeve can remain attached to eliminate melted wax from running off, a common problem with stick and pillar candles, or the sleeve can be removed allowing a more natural flow of the melted wax. The shown support platform can serve as an area to let wax run-off to gather and/or for it to serve as a safety exclusion zone.

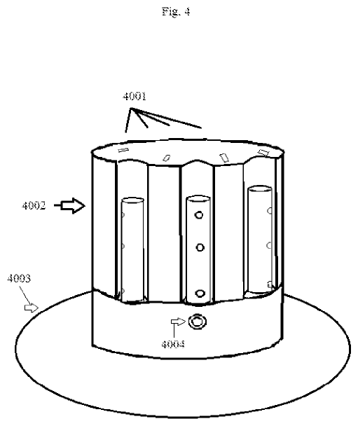

FIG. 5 displays, basically the same features of FIG. 3 (“The extended horizontal platform is shown with its support arms connected to itself and the support platform. The “wire path” in the central area encloses the necessary wiring for the LEDs of the platform”). An additional candle is placed on the horizontal platform. A heat shield is placed under the horizontal platform to disperse some of the heat generated by the first tier candles.

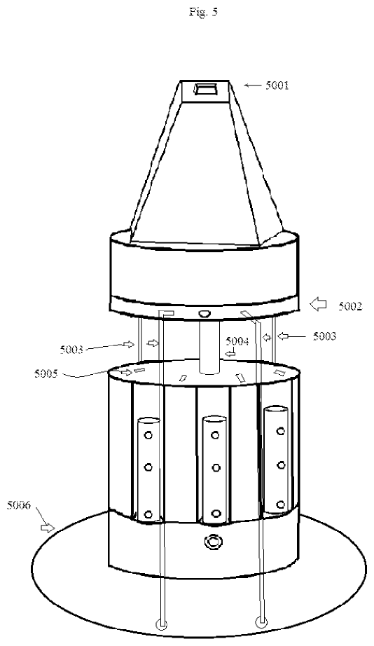

FIG. 6 Is a completed system in the embodiment of FIG. 5, differences being, there is no separation between tier 1 and tier 2.

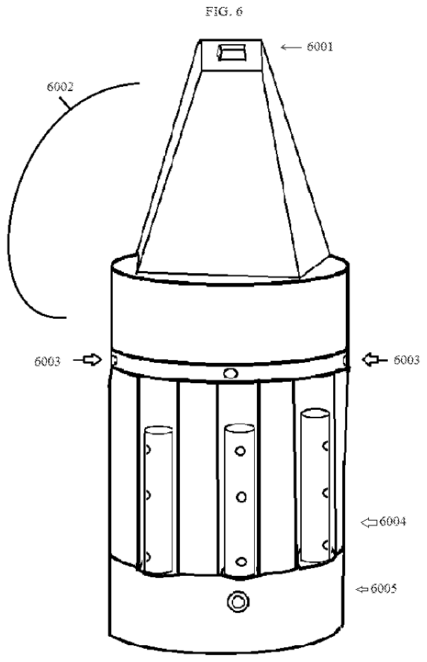

FIG. 7 illustrates the placement of the LEDs into the horizontal platform. The flat end of the LED is adhered to the horizontal disk. The lead wires extending from the LEDs are attached to the upper side of the horizontal platform, and drawn down through the center hole.

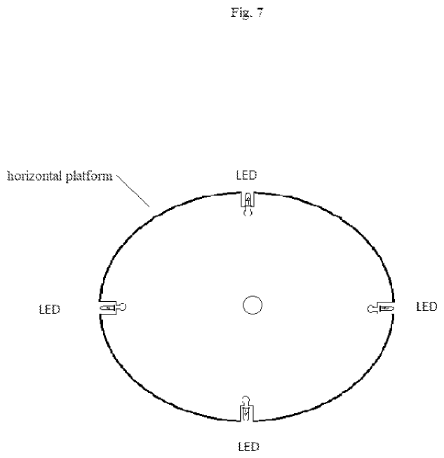

FIG. 8 displays an option to allow a pathway to be created for the placement of the lead wires. The drawings shows the body of the LEDs extending past the body of the horizontal platform, this is done for a better visual understanding, under normal situations, the LED would be embedded into the horizontal platform.

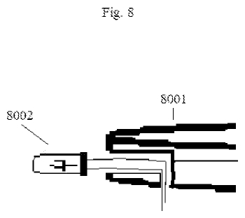

FIG. 9 examines 2 different horizontal platforms. The topmost image shows how a hole is drilled into a piece of material, in this first embodiment the material is acrylic. The hole is large enough to allow the LED to be placed into the hole and adhered. The wire leads will be brought through the hole via a small opening as illustrated in FIG. 8. The lower image illustrates the same principles as the upper, except that two pieces of material, in this example it is acrylic, are placed together. This would allow only the bottom piece needing to be drilled vertically, to allow the wire leads to be pulled through, reducing the possibility of excessive heat transfer. The LEDs in this image are extended past their placement for visual reference.

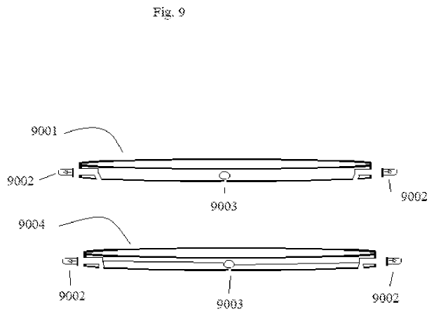

FIG. 10 shows an embodiment where the placement of the LEDs underneath the horizontal platform. Horizontal holes are placed within vertical support members. The left and right support members are shown in a cut out view, showing the placement of the LEDs. A type of lens can be utilized to enhance the viewing angle an prismatic effects in this embodiment. A text label is used to personalize the project. The base encloses the electronic components. The on/off switch is used to control the energy supply to the project.

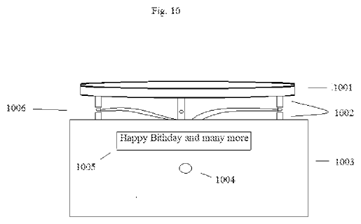

FIG. 11 shows a completed project. The horizontal platform is shown with LEDs and the base with it's on/off switch and the pyramid style candle.

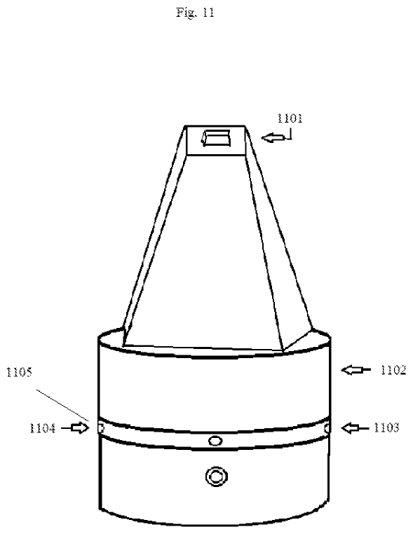

FIG. 12 shows the sleeve that serves as a mold or a permanent sleeve. The first application of this mold is to contain the melted wax until the wax solidifies, then it is removed. The second application is to also serve as a retaining structure while the melted wax is poured and as a retaining structure to eliminate the run-off of melted wax, in this second application it is made of a clear material as to enable a clear field of vision.

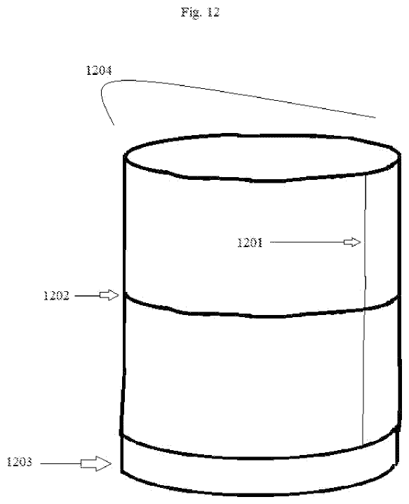

### BRIEF DESCRIPTION OF INVENTION

The following is a brief description of the invention in this application. There can be a plethora of embodiments for this invention, but listed are a few embodiments to convey the basic principles of this application. The essence of this project is to embed Light Emitting Diodes (LED's) into a functional candle. The end result would be the usual experience of a burning candle and various sequencing of the LED's from within the candle itself. The challenge of preventing unintended exposure of the electronic components to open flames has been taken into consideration and resolved. Given normal and standard conditions, through many test burnings, there are no hazards to the heart of the electronics, since the majority of the electronic components are under the base, thus kept at a safe distance from open flames.

### BRIEF SUMMARY

The following is a brief description of the invention in this application. There can be a plethora of embodiments for this invention, but listed are a few embodiments to convey the basic principles of this application. The essence of this project is to embed Light Emitting Diodes (LED's) into a functional candle. The end result would be the usual experience of a burning candle and various sequencing of the LED's from within the candle itself. The challenge of preventing unintended exposure of the electronic components to open flames and melted wax has been taken into consideration and resolved, given normal and liable conditions, through many test burnings. The majority of the electronic components are under the base, thus kept at a safe distance from open flames.

The invention claimed is:

1-19. (canceled)

20. An electronically controlled light system embedded in wax, with afunctional candle comprising: a system of LED lights (light emitting diodes) controlled by means of a device used to coordinate their function.

21. An electronically controlled light system of claim 20, comprising an electronically controlled light system embedded in a candle of, a power source of 9 volts dc other embodiments might include powering the system from conventional electrical means, e.g. 120 VAC, other embodiments may consist of a plethora of electronic components to configure this described system, wherein, said electronically controlled light system comprises polyhypaze (many elements), other embodiments may consist of a plethora of electronic components to this described system, further comprising light emitting diode(s), acrylic rods, power switch, battery, voltage regulator, resistors, microcontroller or other device(s) that can be used to create synchronous/asynchronous lighting effects and an enclosing structure for the electronic components that also serves as a foundation for the other elements above the said enclosing structure wherein, said LED('s) are electronically controlled by said microcontroller or other device that can be used to create synchronous/asynchronous lighting effects that is responsible for the sequencing of said LED('s), comprising of blinking on/off with various timing duration's, fading sequences of gradually going on and off with various timing duration's, the said LED('s) consist a two wire configuration in this embodiment, the use of three or more wire configurations will be used in latter models/variations, wherein the plurality of LED('s) comprising the 12 LED('s) in this embodiment, other embodiments are not limited to 12 LED('s), wherein the layout/presentation pattern consists of calculating the number of degrees in a circle and dividing by the number desired number of columns, in this first embodiment there are four columns symmetrically positioned at 0 degrees, 90 degrees, 180 degrees, and 270 degrees, at each position composes the said LED('s) are embedded in a column vertically/slanted/horizontally, in this first composition there are three said LED('s) per said column, this pattern of placing columns would be repeated until it is completed, the wiring configuration for said LED('s) are laid out in such a manner as not to become overheated by the burning of the candle wick.

22. An electronically controlled light system of claim 20, comprising said LED('s) wire configuration has a plurality of LED('s) whose wires are connected to resistors, if necessary, and in series (or some other configuration) to the microcontroller or other device that can be used to create synchronous/asynchronous lighting, if said LED('s) is drawing less than the maximum allowed of current amount, the said resistor is not necessary, unless other visual effects are desired, one of the wires of said LED('s) will be connected to a “common”, this may consist of a common connected to the positive or negative terminal of the power supply depending on the embodiment, wherein, said electrically controlled system consists of a 9 volt battery, other embodiments may consist of a 3 volt, 18 volt power supply.

23. An electronically controlled light system of claim 20, comprising an electronically controlled light system embedded in a candle, wherein, said vertical columns is affixed to an enclosing structure, this said enclosing structure contains the circuitry.

24. An electronically controlled light system of claim 20, comprising an on/off switch, this first embodiment utilizes a single pole-single throw rotary switch, other variations/embodiments can utilize options such as double throw-double Pole, dip Switches, rotary, single pole-double throw, any configuration that can connect and disconnect the power supply will be adequate,

25. An electronically controlled light system of claim 20, comprising an electronically controlled light system embedded in a candle, wherein, the said series of LED(s) is arranged in a horizontal plane with the LED(s) circling in said horizontal manner, comparable to the vertical manner, yet in a horizontal layout instead.

26. An electronically controlled light system embedded in a candle comprising:
A volume of material that will sustain a flame when given the proper medium, of a fibrous-like composition, natural or man-made, that acts in a capillary manner with said material will sustain a flame when an ignition source is brought near to it, a lighting system that is embedded in said material, wherein, said volume of material will be comprised of paraffin, soy, gel, or other materials that a candle might be composed of, wherein, fibrous-like composition, usually referred as a candle wick, composed of, cotton other material that has good capillary suction that been treated in a manner to maximize it's efficiency to act as a candlewick.

27. An electronically controlled light system of claim 26, comprising a candle with one or a plurality of stages/divisions, when comprising two or more said stages/divisions the first bottom stage is in accordance with previous structural statements, another embodiment can have a plurality of said stages/divisions in which there is a means to make distinctively separate modules, in this embodiment the upper stage/division is pulled upward, separating the base stage/division from said upper stage/division with such supporting means will be provided, as project expands vertically to ensure stability and reduce fire risk, said modules can have different colors, scents, decorative features, said modules are separated by a means of a material that will minimize heat transfer between said stages/divisions, electronically controlled light system embedded in a candle of claim 1 can be placed within any of the said stages/divisions with a means of electronically separating each said stages/division this embodiment has a central piece of conduit that encloses the wiring, said wiring is coiled/arranged in such a manner to allow it to extend the desired distance of each stage/division.

28. An electronically controlled light system of claim 26, comprising a method of assembling and attaching said vertical columns by means of adhering, fusing or screwing, that have embedded light sources to the said base.

29. An electronically controlled light system of claim 26, a method of manufacturing said column(s),
wherein, said column(s) comprising of a material that will maximize visual effects, in this embodiment the material is acrylic, wherein the vertical columns are attached by an adhesive/polymer material or fastening device, such as a screw, the wires of said LED('s) are arranged in such a manner to be laid out from their said columns, through a hole in the top of said base/enclosing structure to connect to said microcontroller, or other device that can be used to create synchronous/asynchronous lighting effects of claim 1, wherein said column(s) have a light source embedded or attached, in this embodiment, acrylic rods are drilled and adhered in a sufficient manner as to hold the said led in position, and by the resulting optical projection is enhanced by the nature of the acrylic rods/tubes, any material with this ability to hold the light source, or have it embedded, is claimed,

30. An electronically controlled light system of claim 26, a method of producing a stage/division, as is the nature and purpose of a candle is to melt it's wax into what is commonly referred to as a wax pool in the industry, said wax pool will cause distortions to the shape of a free standing candle shape, or dripping, or running off of wax, especially when the candle (as this embodiment is), a pillar style without any containing wall-like structure, wherein, said candle can have structurally supportive means to minimize said distortions, dripping, said supportive means can include a layer of high temperature vinyl enclosing said candle portions prone to unfavourable affects, wherein, a said candle can utilize an embodiment, wherein a high temperature wax acts as a shell, the method for constructing this said shell is made by first melting the wax, then pouring it into its mold, in short amount of time the wax will begin to solidify from the outermost area towards the middle, after the desired amount of wax has sufficiently begun to harden, (in this embodiment 10%), the remaining amount of wax is “poured off”, thus allowing for a secondary amount of wax with a lower melting point to be melted and then poured into the previously formed shell, thus resolving issues related to distortions or running off of wax.

31. An electronically controlled light system of claim 26,
comprising a method of manufacturing said horizontal arrangement of said LED('s), in which a solid piece, or pieces are fabricated in a manner to insert and support said LED('s), of clear material, effectively of a shape that is visually esthetically pleasing, consisting of material in this embodiment is acrylic.

32. An electronically controlled light system of claim 7, comprising a sleeve-like composition that will encase said electronically controlled light system embedded in a candle of claim 1, for the purpose of containing/restricting the melted wax portion, said sleeve-like composition is of a clear or opaque material, in the first embodiment, it consists of a clear material to enabling a clear view of the LED(s).

33. An electronically controlled system,

34. An electronically controlled light system of claim 14, comprising of standard components including LED('s), resistors, transistors, batteries, switches, voltage regulators, on/off switches, Integrated Circuits able to synchronize the turning off and on, fading of LED(s),

35. An electronically controlled light system of claim 33, comprising the incorporation of microcontroller(s) to coordinate the output, in this embodiment the output is/are blinking and fading LED('s), said microcontroller is preprogrammed (outside of current project) to output sequence(s) of high and lows, which results in the LED('s) turning on and off and fading,

36. An electronically controlled light system of claim 33, comprising the use of sensors that would have the ability to effect the sequence, frequency or duration of said LED(s), said LED(s) can be of any color that is available from manufactures,

37. An electronically controlled light system of claim 33, comprising a power source, which can include generated, battery or standard household AC (including 110 and 220 VAC).

38. An electronically controlled light system of claim 33, comprising an embodiment of embedding the led elements of claim 34, claim 35, claim 36, or claim 37 into a wax medium with or without a wick, otherwise known as a candle or wax melt.
